(19) United States
(12) Patent Application Publication
(10) Pub. No.: US 2008/0282613 A1
(43) Pub. Date: Nov. 20, 2008

(54) Security Screen

(76) Inventor: Xavier Frank Heads, Queensland (AU)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 10/596,182

(22) PCT Filed: Dec. 2, 2004
(86) PCT No.: PCT/AU04/01697

§ 371 Date: Jun. 2, 2006

(30) Foreign Application Priority Data
Dec. 2, 2003 (AU) 2003906662

(51) Int. Cl. E06B 9/01

(52) U.S. Cl. 49/50

(57) ABSTRACT

A security door or window comprises a security panel (10) [typically a metal grid] which is held in a peripheral frame (15) in an improved manner and without requiring rivets or welding by providing a recess (16) in the edge of the panel and a rib (18) in the peripheral frame which passes into the recess to hold the parts together. When the security door/window is assembled, the panel is trapped and cannot slide out of engagement with the frame.

### FIELD OF THE INVENTION

This invention is directed to a security screen and is particularly directed to a security door screen or security window screen, where the security screen comprises a security panel and a surround frame and where the security panel is attached to the frame in a particular manner. While the invention will be described with reference to a security door, it should be appreciated that no particular limitation is meant thereby.

### BACKGROUND ART

A security screen typically comprises a metal panel which is fixed to a surrounding frame. Such a security screen will typically comprise a screen door which may be a sliding door or a swinging door. Alternatively, the security screen may comprise a sliding security window or a swinging security window.

The security screen is typically formed separately to the normal door or window and will slide or hinge in front of the door or window or behind the door or window. This allows the door window to be opened and the security screen to be closed and locked to provide a measure of security while still providing ventilation.

The metal panel will typically comprise an aluminium panel and it is usual for the panel to be mesh like or gridlike in appearance such that the panel is substantially see-through. Such panels are well-known and a very common type of panel is an aluminium mesh type structure which can be quite decorative and which comprises aluminium tubes or rods which have a diameter of between 3-10 millimetres.

These panels are formed separately and need to be attached to a surrounding frame to form a security screen. The surrounding frame is typically an aluminium extrusion although the surrounding frame may also comprise a steel section.

It is important that the panels are securely attached to the surrounding frame such that the panels cannot be jemmied off or easily ripped out of the surrounding frame. Thus, it is known to use a multiplicity of rivets to secure the panel to the frame. It is also known to use spot welds, crimping, other types of fasteners such as self tapping screws and the like to attach the panel to the surrounding frame.

In most cases, attachment of the panel to the surrounding frame is quite labourious and can sometimes be quite unsightly.

Therefore, there would be an advantage if it were possible to attach a security panel to a surrounding frame in a manner that does not require rivets or welding.

It will be clearly understood that, if a prior art publication is referred to herein, this reference does not constitute an admission that the publication forms part of the common general knowledge in the art in Australia or in any other country.

### OBJECT OF THE INVENTION

It is an object of the invention to provide a security panel that may at least partially overcome some of the above-mentioned disadvantages or provide the consumer with a useful or commercial choice.

In one form, the invention resides in a security panel, the security panel comprising a frame and a panel member, the panel member having a peripheral edge which passes into a cavity in the frame, one of the peripheral edge or the cavity being provided with a projection and the other of the peripheral edge or the cavity being provided with a recess which passes into the projection when the panel member is in the cavity.

Thus, the panel member can be attached to the frame using a “projection in slot” type arrangement, and this prevents the panel member from being easily pulled out of the frame.

The security panel will typically comprise a door or window but no particular limitation is meant thereby and it is envisaged that the security panel may also be used in other areas where such a security panel is required.

The frame will typically be a surrounding frame although it is envisaged that there may be circumstances where the frame only partially surrounds the panel member. If the security panel is a door, it is typical for the surrounding frame to extend entirely about the panel member.

The frame may be of any suitable shape and size depending on its application. If the security panel will be used as a door or window, the frame will typically be substantially rectangular and will have a length of between 0.5-3 metres and a height of between 1-3 metres. This can of course vary to suit.

The frame will typically comprise a metal member and it is usual for the frame to comprise a number of metal members that are attached together to form a surrounding frame or a partially surrounding frame. The metal members may comprise solid metal members, angled metal members, hollow metal members and the like. Typically, the frame will comprise aluminium extrusions.

The frame will typically have a cavity to accommodate an edge of the panel member. The cavity may comprise an open channel. The channel will typically extend substantially, or entirely along the frame. The channel may have a depth of between 5-50 millimetres and a width of between 3-20 millimetres. The depth of the channel can determine the amount of “overlap” between the edge of the panel member and the channel while the width of the channel should be slightly more than the width or thickness of the panel member to enable the panel member to pass into the channel.

It is envisaged that a plurality of such channels may be provided, although for the purposes of simple extrusion, it is considered that a single channel would be most expedient.

The panel member will be of the type to provide a measure of security or deterrent against intrusion. A variety of panel members are commercially available and these typically comprise decorative aluminium gridlike structures which can be cut to shape. However, the panel member need not be limited to this particular choice and may comprise steel members, a metal or other type of sheet or plate which may contain openings and the like. For the purpose of ventilation and view, it is preferred that the panel member does comprise a decorative gridlike structure.

The panel member will comprise an edge which will typically not be continuous but which will comprise end parts (or prongs) of the gridlike structure. These end parts may be provided with a recess. It is preferred that the recess on each end part is such that a “continuous recess” is formed. However, it is also envisaged that only some of the end parts or only a portion of the edge of the panel member is provided with a recess.

If the edge is provided with a recess, the recess may be substantially U-shaped in cross-section although no particular limitation is meant thereby and the recess may have other shapes such as a V shape, an inverted T shape, a truncated pyramid shape and the like. The recess may also have an irregular shape. The shape of the recess may be designed to promote locking of the panel member to the frame.

However, it should be understood that the edge need not be formed with a recess and may instead be formed with a projection or may be formed with a projection and a recess.

If the edge is provided with a recess, the channel or cavity in the frame is typically provided with a projection that can pass into the recess to prevent the panel member from being pulled out of the cavity. It is envisaged that the projection will be of a type and shape and size to prevent the panel member from being pulled out of the cavity.

It is preferred that the projection extends substantially along an inside wall of the cavity or channel to provide a good mating with the recess. It is envisaged that the projection may comprise a plurality of separate projections.

The projection will typically have a shape which corresponds to the shape of the recess. For instance, if the recess comprises an inverted T shaped recess, the projection may comprise a T shaped projection. Similarly, if the recess comprises a simple U shaped recess, the projection may comprise a rib and the like. Therefore, no particular limitation is meant to be placed on the shape of the projection and the recess.

In a preferred embodiment, the panel member will be provided with the recess and the frame will be provided with the projection. However, it is envisaged that the arrangement could be the other way round or that each of the recess and the frame is provided with a projection and a recess.

It is also envisaged that the panel member (or the frame) may be provided with more than one recess. For instance, a recess may be provided on the front face of the edge of the panel member and on the rear face of the edge of the panel member. Alternatively, or in addition thereto, a further recess may be provided on the front face such that the front face comprises a pair of spaced apart recesses to provide further security of the attachment of the panel member to the frame. Similarly, more than one projection may be provided to lock into the more than one recess.

It is particularly preferred that the arrangement is such that the frame and the panel member can be slid together typically with the cavity of the panel member sliding over the edge of the frame member and during this sliding movement, the projection and the recess engage to prevent the panel member from being pulled out of the cavity.

### BRIEF DESCRIPTION OF THE DRAWINGS

An embodiment of the invention will be described with reference to the following drawings in which:

FIG. 1. Illustrates a plan view of part of the panel member and particularly showing the edge area which is provided with a recess.

FIG. 2. Illustrates a section view showing the attachment of the panel member of FIG. 1 to a frame.

### BEST MODE

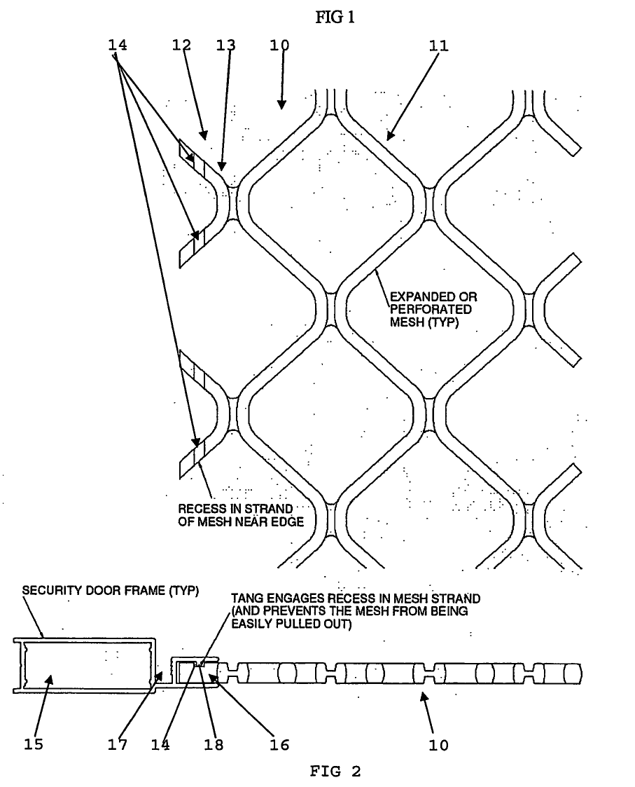

In a preferred embodiment, the invention is quite simple and comprises a frame member 10 which can be of commercial design and typically comprises an aluminium gridlike structure 11. Frame member 10 is typically rectangular when viewed in plan and will therefore have an edge 12. The edge 12 is simply a cut edge of the gridlike structure and will therefore comprise a portion of the gridlike structure. In the particular embodiment illustrated in FIG. 1, the edge comprises a plurality of prongs 13.

These prongs 13 are provided with a recess 14 in such a manner that all the recesses 14 are aligned when viewed from one edge to provide a “continuous” type recess. This is also evident in FIG. 2.

Frame member 10 is attached to a surrounding frame 15 which comprises an extruded aluminium section. Surrounding frame 15 has an inner cavity or channel portion 16 which is open ended. Behind inner channel portion 16 is another small channel portion 17 the function of which is to accommodate the spline which attaches the fly screen over the top of frame member 10. This is known.

Inner channel portion 16 is formed with a small inwardly extending tang or rib 18. Tang 18 is designed to pass into the recesses 14 when the frame member 10 is inserted into channel portion 16. Specifically, frame member 10 is captured by channel portion 16. Once the frame member is in channel portion 16, it cannot be pulled out of the open mouth of channel portion 16 because of the engagement of tang 18 in recesses 14.

Typically, a security doorframe is assembled by providing at least two surrounding frame portions 15.

Therefore, once assembled, the frame member 10 is securely held by the surrounding doorframe 15 and in such a manner that the frame member cannot be easily pulled out. Separate rivets and welds and other types of fasteners are not required to attach the frame member to the doorframe. In fact, the entire attachment is concealed and therefore aesthetically pleasing. Also, the time and effort involved in assembling the frame member to the doorframe is much less.

Throughout the specification and the claims (if present), unless the context requires otherwise, the term “comprise”, or variations such as “comprises” or “comprising”, will be understood to apply the inclusion of the stated integer or group of integers but not the exclusion of any other integer or group of integers.

It should be appreciated that various other changes and modifications can be made to any embodiment described without departing from the spirit and scope of the invention.

1. A security panel for a window or door, the panel comprising a frame and a substantially rigid panel member, the panel member having a peripheral edge which passes into a cavity in the frame, the cavity having a pair of opposed spaced apart sidewalls, at least one sidewall containing a projection extending therefrom and into the cavity and the peripheral edge containing a recess which passes into the projection when the panel member is in the cavity, thereby preventing removal of the panel member from the frame.

2. The panel of claim 1, wherein the frame comprises at least one elongate member formed with at least one cavity into which an edge of the panel member passes.

3. The panel of claim 2, wherein the cavity comprises an open channel which extends at least partially along the elongate member.

4. The panel of claim 3, wherein the panel member comprises a metal grid structure.

5. The panel of claim 4, wherein the peripheral edge of the panel member comprises end parts of the metal grid structure.

6. The panel of claim 5, wherein at least some of the end parts are provided with the recess.

7. The panel of claim 6, wherein all the end parts are provided with the recess and the recesses are in linear alignment.

8. The panel of claim 6, wherein the cavity in the frame is provided with an integrally formed longitudinal projection that passes into the recess on the panel member to prevent the panel member from being pulled out of the cavity.

9. The panel of claim 8, wherein the cavity comprises an elongate channel which contains the projection.
